(19) United States
(12) Patent Application Publication
(10) Pub. No.: US 2016/0154844 A1
(43) Pub. Date: Jun. 2, 2016

(54) INTELLIGENT MEDICAL IMAGE AND MEDICAL INFORMATION SEARCH METHOD

(71) Applicant: Infinitt Healthcare Co., Ltd., Seoul (KR)

(72) Inventors: Minsoo PARK, Seoul (KR); Seon Hee YOO, Incheon (KR)

(21) Appl. No.: 14/603,366

(22) Filed: Jan. 23, 2015

(30) Foreign Application Priority Data
Nov. 29, 2014 (KR) 10-2014-0169244
Jan. 21, 2015 (KR) 10-2015-0010198

(51) Int. Cl. G06F 17/30

(52) U.S. Cl. CPC G06F 17/30395; G06F 17/30554; G06F 17/3028

(57) ABSTRACT

An intelligent medical image search method includes an existing analysis document indexing step of indexing existing analysis documents, an existing analysis document storing step of storing the indexed analysis documents, a new analysis document inputting-step of inputting a new analysis document through a user interface, and a similar analysis document searching step of searching for the existing analysis documents of a similar symptom using similarity to a symptom of a patient on the basis of the new analysis document.

### CROSS-REFERENCE TO RELATED APPLICATION

This application claims priority to and the benefit of Korean Patent Application No. 10-2014-0169244, filed on Nov. 29, 2014, and Korean Patent Application No. 10-2015-0010198, filed on Jan. 21, 2015, the disclosures of which are incorporated by reference herein in their entireties.

### BACKGROUND

1. Technical Field

The present invention relates to a medical image and medical information search method, and more particularly, to an intelligent medical image and medical information search method.

2. Discussion of Related Art

Recently, doctors wish to create analysis documents with reference to previously analyzed results when analyzing medical, images and the like. However, an existing picture archiving and communication system (PACS) actually uses patient information as a reference for search and thus the entire system cannot be searched using keywords. The search results are restricted to images of patients and reports and thus it is not possible to find documents such as dissertations.

Therefore, when a medical analyst performs analysis, it is difficult for the medical analyst to freely search the innumerable analyzed results and materials that are accumulated and to refer to the analyzed results and materials that are found. As a result, doctors use only currently captured images of a patient to provide a diagnosis or an opinion on the medical images of the patient. Thus, when a doctor performs analysis using only the captured images, the doctor cannot refer to the vast array of analysis documents from other doctors that are accumulated, and it is thus difficult to guarantee quality of analyzed details.

### SUMMARY

The present invention is made to solve the above-mentioned problem and is directed to an intelligent medical image and medical information search method that allows easy search hi a vendor neutral archive (VNA) environment for existing analysis documents or dissertations relevant to medical images or the like for similar symptoms in real time while an analysis document is created.

According to an aspect of the present invention, there is provided an intelligent medical image search method including: an existing analysis document indexing step of indexing existing analysis documents; an existing analysis document storing step of storing the indexed analysis documents; a new analysis document inputting step of inputting a new analysis document through a user interface; and a similar analysis document searching step of searching for the existing analysis documents of a similar symptom using similarity to a symptom of a patient on the basis of the new analysis document.

The existing analysis documents indexed in the existing analysis document indexing step may be existing analysis documents which are collected from an analysis document database in which non-indexed analysis documents are stored in advance or existing analysis documents which are indexed when the analysis documents are stored through the user interface.

The analysis documents may include metadata of medical images.

The intelligent medical image search method may further include a similar analysis document displaying step of displaying one or more analysis documents of a similar symptom on the user interface.

The new analysis document inputting step, the similar analysis document searching step, and the similar analysis document displaying step may be executed in real time and the similar analysis documents reflecting an input of all or a part of a new analysis document or correction of all or a part of the new analysis document may be searched for and displayed through the user interface in real time.

The similar analysis document searching step may include: an existing analysis document matrix expressing step of expressing a matrix having details of the existing analysis documents and one or more of words included in the details of the existing analysis documents; a new analysis document matrix expressing step of expressing a matrix having details of a new analysis document or one or more of words included in the new analysis document; an eigenvalue and eigenvector deriving step of deriving an eigenvalue and an eigenvector by singular value decomposition of the matrix of the existing analysis documents and the matrix of the new analysis document; and a similarity determining step of determining similarities between the existing analysis documents and the new analysis document by cosine similarity calculation.

The similarly analysis document displaying step may include displaying similarities to the symptom of the patient together on one side of the analysis documents of the similar symptom.

According to another aspect of the present invention, there is provided an intelligent medical information search method including: an existing medical information indexing step of indexing existing medical information; an existing medical information storing step of storing the indexed medical information; a new medical information inputting step of inputting new medical information through a user interface; and a similar medical information searching step of searching for the existing medical information of a similar symptom using similarity to a symptom of a patient on the basis of the new medical information.

The existing medical information indexed in the existing medical information indexing step may be existing medical information which is collected from one or more medical information databases in which non-indexed medical information is stored in advance or existing medical information which is indexed when the medical information is stored through the user interface.

The existing medical information may include one or more of analysis documents including metadata of medical images, dissertations relevant to medical information, and reports relevant to medical information.

The intelligent medical information search method may further include a similar medical information displaying step of displaying one or more pieces of medical, information of a similar symptom on the user interface.

The new medical information inputting step, the similar medical information searching step, and the similar medical information displaying step may be executed in real time and the similar medical information reflecting an input of all or a part of new medical information or correction of all or a part of the new medical information may be searched for and displayed through the user interface in real time.

The similar medical information searching step may include: an existing medical information matrix expressing step of expressing a matrix having details of the existing medical information and one or more of words included in the details of the existing medical information; a new medical information matrix expressing step of expressing a matrix having details of new medical information or one or more of words included in the new medical information; an eigenvalue and eigenvector deriving step of deriving an eigenvalue and an eigenvector by singular value decomposition of the matrix of the existing medical information and the matrix of the new medical information; and a similarity determining step of determining a similarity between the existing medical information and the new medical information by cosine similarity calculation.

The similarly medical information displaying step may include displaying similarities to the symptom of the patient together on one side of the medical information of the similar symptom.

The new medical information may be a new analysis document or a research dissertation which is input through the user interface.

According to the aspects of the present invention, first, it is possible to provide an intelligent medical image and medical information search method that can allow search in the VNA environment for documents such as relevant dissertations as well as patient images and reports.

Second, it is possible to make a search based on keywords in the VNA environment and to easily search and check a variety of data (images, reports, and documents).

Third, it is possible to apply found materials to an analysis document currently being created and to store the found materials in a particular file format when a research dissertation is being created.

Fourth, it is possible to provide an intelligent medical image and medical information search method that has high utility of easily finding images of other patients having symptoms similar to a suspected symptom on the basis of a captured image. That is, when an analysis document is to be created, by finding similar main topics or symptoms among similar analyzed eases of other patients that were previously imaged and comparing them to currently captured images, it is possible to enhance quality of analyzed details by using other images of similar symptoms in the diagnosis when the analysis document is created.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block diagram illustrating the entire configuration of a system to which an intelligent medical image and medical information search method according to an exemplary embodiment of the present invention is applied;

FIG. 2 is a block diagram illustrating the detailed configuration of the system to which an intelligent medical image and medical information search method according to an exemplary embodiment of the present invention is applied;

FIG. 3 is a flowchart illustrating an intelligent medical image and medical information search method according to an exemplary embodiment of the present invention;

FIG. 4 is a diagram illustrating an example of a screen on which a search result for similar analysis documents is displayed according to an exemplary embodiment of the present invention;

FIG. 5 is a diagram illustrating an example of a screen on which one of the similar analysis documents illustrated in FIG. 4 is opened; and

FIG. 6 is a diagram illustrating an example of a screen on which similar analysis documents found in real time while an analysis document is created are displayed.

### DETAILED DESCRIPTION OF EXEMPLARY EMBODIMENTS

Exemplary embodiments of the present invention will be described in detail below with reference to the accompanying drawings. Terms or words used in this description or the appended claims should not be analyzed to have general or colloquial meanings, but should be analyzed to have meanings and concepts corresponding to the technical spirit of the present invention, on the basis of the principle that an inventor can appropriately define concepts of terms for the purpose of explaining the present invention in a best mode.

Therefore, embodiments described in this description and the configurations illustrated in the drawings are merely best exemplary embodiments of the present invention and do not represent all the technical spirit of the present invention. Accordingly, it should be understood by those skilled in the art that there may be various equivalents and modifications with which the exemplary embodiments can be replaced at the time of filing of the present invention.

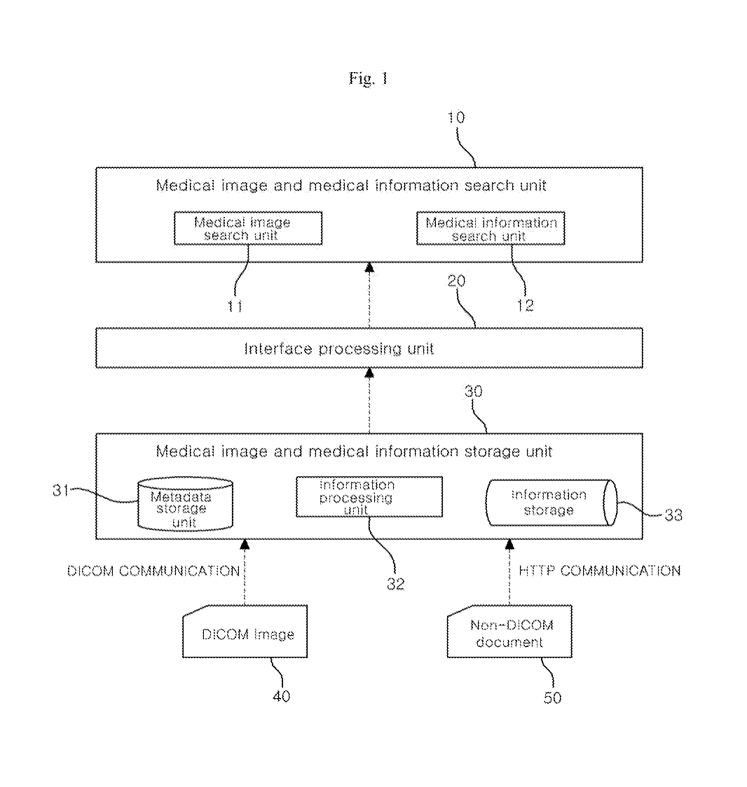

FIG. 1 is a block diagram illustrating the entire configuration of a system to which an intelligent medical image and medical information search method according to an exemplary embodiment of the present invention is applied.

A system according to the present invention includes a medical image and medical information storage unit 30 in which medical images and medical information are stored, an interface processing unit 20, and a medical image and medical information search unit 10. As illustrated in FIG. 1, the medical image and medical information storage unit 30 receives a standard medical image, a DICOM image 40, through DICOM communication and stores the image. At this time, metadata relevant to the medical image is also stored in a metadata storage unit 31. An information storage 33 receives a non-DICOM document 50 such as various analysis documents or various documents other than medical images through HTTP communication and stores the documents in addition to the medical images. An information processing unit 32 performs a crawler function, an indexing function, and an index file generating function, which will he described later. The medical image and medical information search unit 10 searches the medical image and medical information storage unit 30 and provides information that is found through the interface processing unit 20 on the basis of information input by a medical analyst.

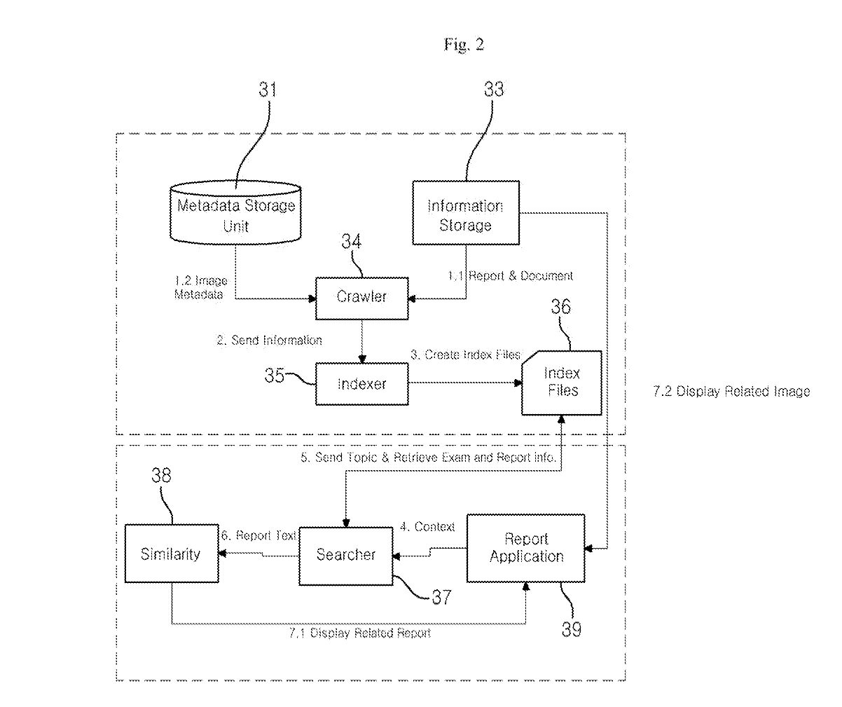

FIG. 2 is a block diagram illustrating the detailed configuration of the system to which the intelligent medical image and medical information search method according to the exemplary embodiment of the present invention is applied.

In FIG. 2, a crawler 34 crawls in the metadata storage unit 31 and the information storage 33, that is, collects medical images and analysis documents which are stored in advance in a non-indexed state through a medical image and analysis document database (the information storage 33 herein), indexes the collected medical images and analysis documents through an indexer 35, and generates an index file 36 or updates an index file 36 that has already been generated. When a captured medical image is stored, the indexer 35 may generate the index tile 36 by indexing the analysis document or may update the generated index file 36 that has already been generated.

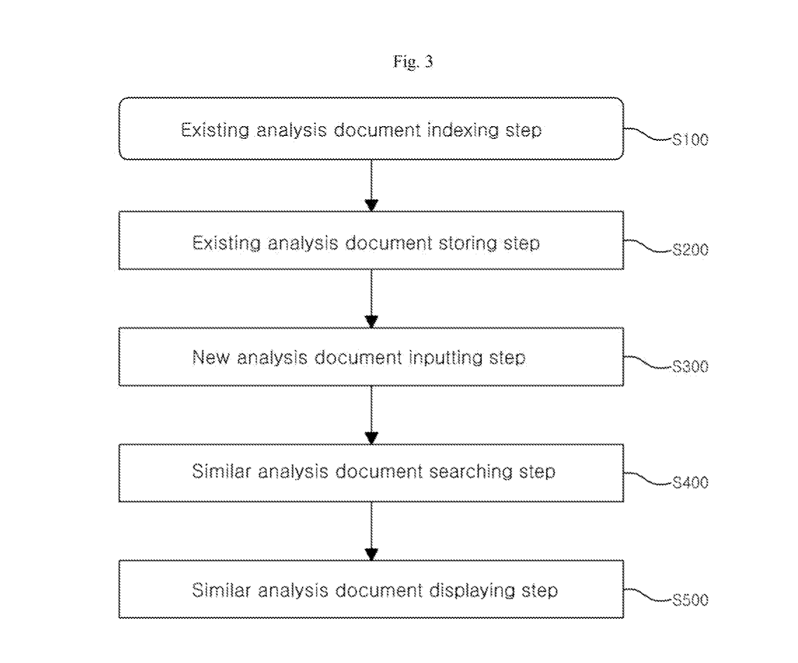

FIG. 3 is a flowchart illustrating an intelligent medical image and medical information search method according to an exemplary embodiment of the present invention.

An intelligent medical image search method according to the present invention includes: an existing analysis document indexing step (S100) of indexing existing analysis documents; an existing analysis document storing step (S200) of storing the indexed analysis documents; a new analysis document inputting step (S300) of inputting a new analysis document through a user interface; and a similar analysis document searching step (S400) of searching for the existing analysis documents of a similar symptom using similarity to a patient symptom on the basis of the new analysis document.

Here, the existing analysis documents indexed in the existing analysis document indexing step may be existing analysis documents which are collected from an analysis document database in which non-indexed analysis documents are stored in advance or may be existing analysis documents which are indexed when a medical image is analyzed and stored through the user interface. The analysis documents may include metadata of medical images.

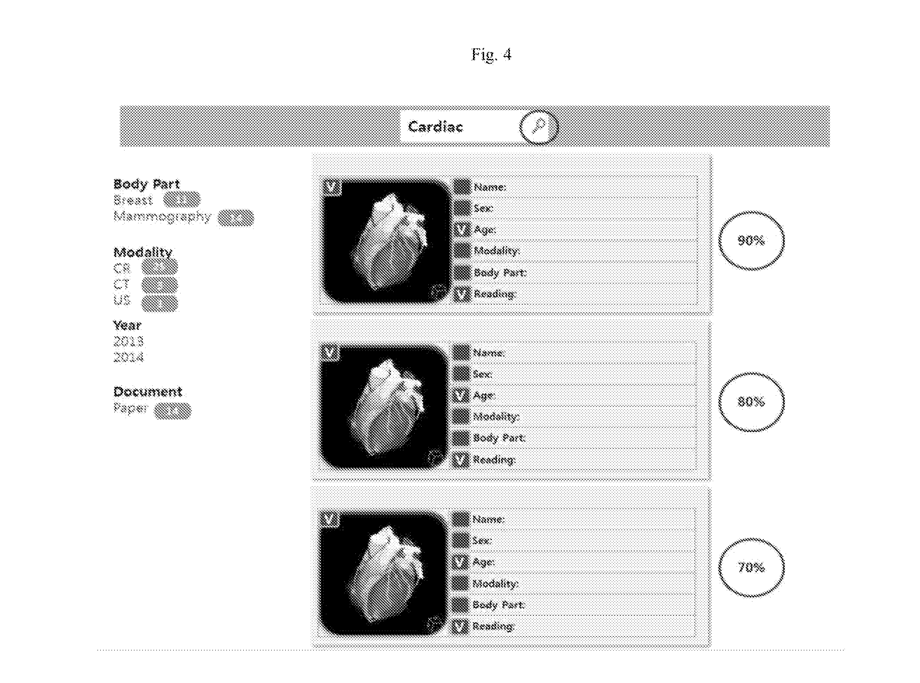

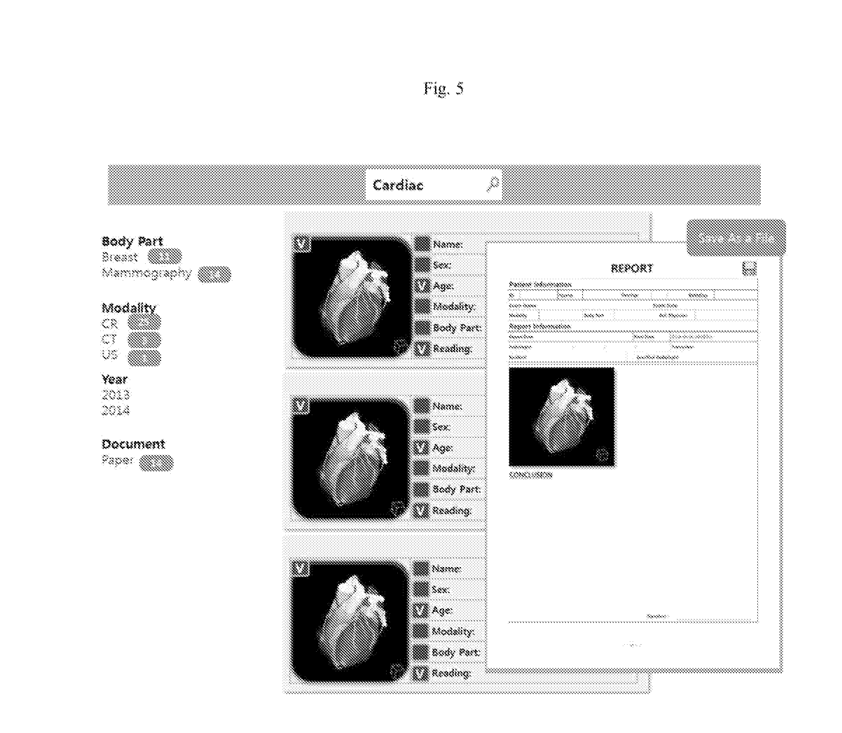

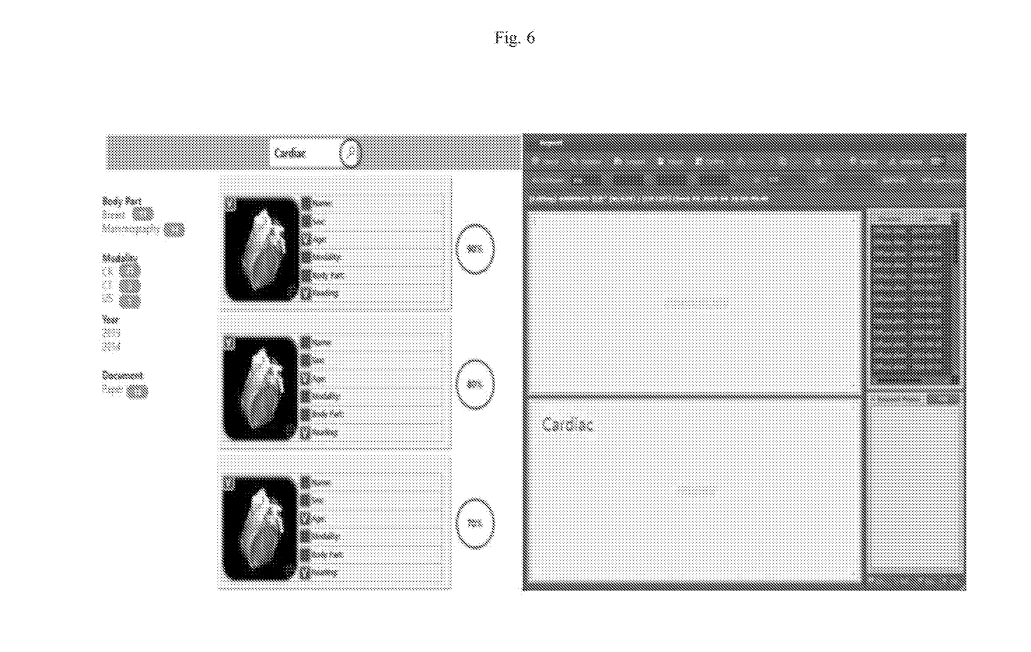

As illustrated in FIG. 3, the intelligent medical image search method may further include a similar analysis document displaying step (S500) of displaying one or more analysis documents of a similar symptom on the user interface. FIG. 4 is a diagram illustrating an example in which a search result for similar analysis documents is displayed on a screen and FIG. 5 is a diagram illustrating an example in which a specific case is opened. As illustrated in FIG. 6, a medical analyst may search for and display similar analysis documents through the user interface in real time while creating an analysis document and viewing a captured medical image.

Here, the similar analysis document searching step may include: an existing analysis document matrix expressing step of expressing a matrix having details of the existing analysis documents and one or more of words included in the details of the existing analysts documents; a new analysis document matrix expressing step of expressing a matrix having details of a new analysis document being created by the medical analyst or one or more of words included in the new analysis document; an eigenvalue and eigenvector deriving step of deriving an eigenvalue and an eigenvector by singular value decomposition of the matrix of the existing analysis documents and the matrix of the new analysis document; and a similarity determining step of determining similarities between the existing analysis documents and the new analysis document by cosine similarity calculation.

The similarly analysis document displaying step may include displaying similarities to the patient's symptom, that is, similarity values of the analysis documents in the similarity determining step, together on one side of the analysis documents of the similar symptom which has been derived in the similarity determining step.

The medical image search method according to the present invention may be extended to a medical information search method for one or more of analysis documents including metadata of medical images, dissertations relevant to medical information, and reports relevant to medical information.

That is, the intelligent medical information search method according to the present invention includes: an existing medical information indexing step of indexing existing medical information; an existing medical information storing step of storing the indexed medical information; a new medical information inputting step of inputting new medical information through a user interface; and a similar medical information searching step of searching for the existing medical information of a similar symptom using, similarity to a patient's symptom on the basis of the new medical information.

As described above, the existing medical information indexed in the existing medical information indexing step may be existing medical information which is collected from one or more medical information databases in which non-indexed medical information is stored in advance or may be existing medical information which is indexed when the medical information is stored through the user interface.

As described above, the intelligent medical information search method may further include a similar medical information displaying step of displaying one or more pieces of medical information of a similar symptom on the user interface.

As described above, the new medical information inputting step, the similar medical information searching step, and the similar medical information displaying step may be executed in real time and may enable the similar medical information reflecting an input of all or a part of new medical information or correction of all or a part of the new medical information through the user interface to be searched for and displayed in real time.

The similar medical information searching step may include: an existing medical information matrix expressing step of expressing a matrix having details of the existing medical information and one or more of words included in the details of the existing medical information; a new medical information matrix expressing step of expressing a matrix having details of the new medical information or one or more of words included in the new medical information; an eigenvalue and eigenvector deriving step of deriving an eigenvalue and an eigenvector by singular value decomposition of the matrix of the existing medical information and the matrix of the new medical information; and a similarity determining step of determining a similarity between the existing medical information and the new medical information by cosine similarity calculation.

The similar medical information displaying step may include displaying similarities to the patient's symptom together on one side of the medical information of the similar symptom.

The new medical information may be a new analysis document or a research dissertation which is input through the user interface.

What is claimed is:

1. An intelligent medical image search method comprising:
an existing analysis document indexing step of indexing existing analysis documents;
an existing analysis document storing step of storing the indexed analysis documents;
a new analysis document inputting step of inputting a new analysis document through a user interface; and
a similar analysis document searching step of searching for the existing analysis documents of a similar symptom using similarity to a symptom of a patient on the basis of the new analysis document.

2. The intelligent medical image search method according to claim 1, wherein the existing analysis documents indexed in the existing analysis document indexing step are existing analysis documents which are collected from an analysis document database in which non-indexed analysis documents are stored in advance or existing analysis documents which are indexed when the analysis documents are stored through the user interface.

3. The intelligent medical image search method according to claim 2, wherein the analysis documents include metadata of medical images.

4. The intelligent medical image search method according to claim 1, further comprising a similar analysis document displaying step of displaying one or more analysis documents of a similar symptom on the user interface.

5. The intelligent medical image search method according to claim 4, wherein the new analysis document inputting step, the similar analysis document searching step, and the similar analysis document displaying step are executed in real time and the similar analysis documents reflecting an input of all or a part of a new analysis document or correction of all or a part of the new analysis document are searched for and displayed through the user interface in real time.

6. The intelligent medical image search method according to claim 1, wherein, the similar analysis document searching step includes;
an existing analysis document matrix expressing step of expressing a matrix having details of the existing analysis documents and one or more of words included in the details of the existing analysis documents;
a new analysis document matrix expressing step of expressing a matrix having details of a new analysis document or one or more of words included in the new analysis document;
an eigenvalue and eigenvector deriving step of deriving an eigenvalue and an eigenvector by singular value decomposition of the matrix of the existing analysis documents and the matrix of the new analysis document; and
a similarity determining step of determining similarities between the existing analysis documents and the new analysis document by cosine similarity calculation.

7. The intelligent medical image search method according to claim 4, wherein the similarly analysis document displaying step includes displaying similarities to the symptom of the patient together on one side of the analysis documents of the similar symptom.

8. An intelligent medical information search method comprising:
an existing medical information indexing step of indexing existing medical information;
an existing medical information storing step of storing the indexed medical information;
a new medical information inputting step of inputting new medical information through a user interface; and
a similar medical information searching step of searching for the existing medical information of a similar symptom using similarity to a symptom of a patient on the basis of the new medical information.

9. The intelligent medical information search, method according to claim 1, wherein the existing medical information indexed in the existing medical information indexing step is existing medical information which is collected from one or more medical information databases in which non-indexed medical information is stored in advance or existing medical information which is indexed when the medical information is stored through the user interface.

10. The intelligent medical information search method according to claim 9, wherein, the existing medical information includes one or more of analysis documents including metadata of medical images, dissertations relevant to medical information, and reports relevant to medical information.

11. The intelligent medical information search method according to claim 8, further comprising a similar medical information displaying step of displaying one or more pieces of medical information of a similar symptom on the user interface.

12. The intelligent medical information search method according to claim 11, wherein the new medical information inputting step, the similar medical information searching step, and the similar medical information displaying step are executed in real time and the similar medical information reflecting an input of all or a part of new medical information or correction of all or a part of the new medical information is searched for and displayed through the user interface in real time.

13. The intelligent medical information search method according to claim 8, wherein the similar medical information searching step includes:
an existing medical information matrix expressing step of expressing a matrix having details of the existing medical information and one or more of words included in the details of the existing medical information;
a new medical information matrix expressing step of expressing a matrix having details of new medical information or one or more of words included in the new medical information;
an eigenvalue and eigenvector deriving step of deriving an eigenvalue and an eigenvector by singular value decomposition of the matrix of the existing medical information and the matrix of the new medical information; and
a similarity determining step of determining a similarity between the existing medical information and the new medical information by cosine similarity calculation.

14. The intelligent medical information search method according to claim 11, wherein the similar medical information displaying step includes displaying similarities to the symptom of the patient together on one side of the medical information of the similar symptom.

15. The intelligent medical information search method according to claim 8, wherein the new medical information is a new analysis document or a research dissertation which is input through the user interface.
